(19) United States
(12) Patent Application Publication
(10) Pub. No.: US 2003/0037708 A1
(43) Pub. Date: Feb. 27, 2003

(54) High early strength cementitous compositions containing glass powder

(75) Inventor: Tarig M. Monawar, New York, NY (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Zstone Technologies, LLC

(21) Appl. No.: 10/272,130

(22) Filed: Oct. 15, 2002

Related U.S. Application Data
(63) Continuation of application No. PCT/US01/11863, filed on Apr. 12, 2001.

(51) Int. Cl. C04B 14/22

(52) U.S. Cl. 106/713; 106/716

(57) ABSTRACT

Cementitious compositions, which may make use of waste glass, comprise glass material, alkali metal aluminate and a cement. Also provided are cementitious binders and solidifiable cementitious compositions (such as mortars and concretes) incorporating the cementitious compositions. The cementitious composition is mixed with water to form the cementitious binder, and aggregate is added to the cementitious binder to form the solidifiable cementitious compositions. Solidifiable cementitious compositions formed from the cementitious compositions have superior early and long-term strength.

### CROSS-REFERENCE TO RELATED APPLICATION

This is continuation of International Application No. PCT/US01/11863, filed Apr. 12, 2001, which was published in the English language on Oct. 25, 2001 under the International Publication No. WO 01/79132A1.

### BACKGROUND OF THE INVENTION

The ecologically sound disposal of post-consumer municipal waste has become a matter of increasing concern in recent years with the decreasing availability of landfill space. Considering that post-consumer waste glass accounts for a substantial percentage of this waste, there is a continuing effort to recover and use waste glass that would otherwise end-up in landfills.

Currently, most post-consumer recovered waste glass is used by glass manufacturers in the production of new glass articles such as bottles. But, only a limited amount of the available supply of waste glass can be used towards the production of new glass articles because manufacturers can only use waste glass that has been pre-sorted by color and type. This excludes waste glass that is of mixed colors (“mixed color waste glass”), i.e., where not all of the glass is the same color, but also includes glass pieces of different colors. Mixed color waste glass is costly to sort by color and type. Alternative uses for waste glass that cannot be used in the production of new glass articles have been developed, such as the use of waste glass in the production of fiberglass, in the process of sand-blasting, and in the production of abrasive materials. Nonetheless, this still leaves large amounts of potentially recyclable mixed color waste glass that must be disposed of in landfills, exacerbating the shortage of landfill space, particularly in the vicinity of large cities. Thus, there has been a continuing effort to find additional uses for mixed color waste glass.

One use for mixed color waste glass that has been investigated is as an aggregate in building and construction materials, such as in asphalt for street paving and in concrete to make glass concrete. In these cases the glass is crushed into smaller pieces and added to the binder materials as a filler or extender; the waste glass in these cases has no binding properties of its own. While these applications do provide additional uses for mixed color waste glass, it may not be sufficiently cost effective to be commercially practicable in the many geographical areas where conventional aggregates are relatively inexpensive.

A more constructive use for the waste glass is as a pozzolan. A pozzolan is a cementitious material added to a cement composition to prevent deterioration and increase the long-term strength of concrete and mortar products made from the cement composition. Because pozzolans are typically less expensive than conventional cements, such as Portland cement, when a portion of the conventional cement is replaced with a pozzolan, the overall cost of the cement composition is reduced.

In recent years the use of waste materials such as slag and fly ash as pozzolans in cementitious compositions for use in construction trades has become relatively widespread. The widespread use of these waste materials as pozzolans is due in part to the development of chemical activators that when included along with the pozzolans in a cementitious composition produce a cementitious composition whose strength properties are comparable to conventional cementitious compositions.

However, waste glass has been little used as a pozzolan in the construction industry because products based on cementitious compositions that contain waste glass as a pozzolan are typically inferior to products formed from cementitious compositions containing only conventional cements, such as Portland cement. In particular, it has been observed that cement formulations that include waste glass powder as a pozzolan produce low early strength properties because of the low pozzolanic reactivity of waste glass powder, and consequently such cement formulations can be used only in construction applications where low early strength properties are not detrimental, such as in stabilizing mine backfills. Accordingly, it would be desirable to find a chemical activator that when included in a cementitious composition with a glass powder pozzolan results in a cementitious composition that has early strength properties comparable or superior to conventional cement compositions. Such cementitious compositions would have greater applicability in the construction industry and increase the use of waste glass as a pozzolan, while at the same time being more cost effective than conventional cement formulations. Unfortunately, the chemical activators used for other waste pozzolan materials such as fly ash and have not worked for glass powder because of the high sodium oxide content of glass powder.

Given the foregoing, there is a continuing need for a cementitious composition that incorporates both waste glass as a pozzolan and a chemical activator effective for use with waste glass, so that products made from this cementious composition have early strength and long-term strength properties comparable or superior to products made from conventional cement compositions.

### BRIEF SUMMARY OF THE INVENTION

The present invention relates to a cementitious composition that comprises cement, glass powder and an alkali metal aluminate.

The present invention also includes a cementitious binder composition comprising a mixture of water and the cementitious composition.

The present invention also includes a solidifiable cementitious composition, such as a mortar or concrete, comprising the cementitious binder composition and an aggregate.

### DETAILED DESCRIPTION OF THE INVENTION

By “cement” is meant an inorganic compound that when combined with water sets to form a hard product as a result of the hydration of the inorganic compound. A “cementitious composition” is a material that has binding properties when mixed with water and includes both conventional cements, like Portland cement, and also glass powder as a pozzolan as well as other, optional components, such as cement additives. By “early strength properties” is meant the strength properties and performance that a material exhibits 24 hours after completion of molding.

The ingredients of the cementitious composition prepared according to the present invention will now be discussed in greater detail. Subsequently, products that can be made from the cementitious composition such as a cementitious binder and solidifiable cementitious compositions such as concrete and mortar materials, will be discussed.

All parts, percentages and ratios used herein are expressed by weight unless otherwise specified. All documents cited are incorporated herein by reference.

The cementitious compositions of the present invention contain glass powder as a pozzolan and alkali metal aluminate, as well as conventional cement such as Portland cement. This glass powder is often less expensive than conventional cement and by replacing a portion of the conventional cement with the powder, the cost of the overall cementitious composition can be reduced.

Glass powder suitable for use in the present invention is formed from glass material including soda-lime glass, borosilicate glass, and lead glass. Soda-lime glass, which is a mixture of silica, Na2O, and CaO is the most common form of glass used today and the most common form of post-consumer waste glass. Borosilicate glass, which is a mixture of silica and B₂O₃, is less common but still widely used in materials because of its resistance to chemical and temperature degradation. The most common form of borosilicate glass is PYREX glass. Lead glass, a mixture of silica, Na₂O, and PbO, may also be used, although it is less common than the previous two types in post-consumer waste glass. These glass materials may include optional modifiers and additives such as metal oxides and gallium or tin, which contribute to glass vitrification. The glass materials may also include various chemical impurities such as ceramic and metal wastes. Metal wastes include quantities of iron and lead, which have not been added to the glass material as chemical modifiers. The glass material used herein may be of any color, and may be mixed by color, and must itself be freed of contaminants such as paper, foils, glues, foodstuffs and the like by a thorough cleaning of the glass material. Suitable processes for removing these contaminants from glass material are well-known to those of ordinary skill in the art.

Additionally, it is preferred that the glass material added to the cementitious compositions does not contain high quantities of certain modifiers and intermediates. Notably, it is preferred that the glass material contains less than 10 wt % of K₂O, and less than 2 wt % of P₂O₅. It is also preferred that the present cementitious compositions be free of quaternary ammonium silicates.

Specifically excluded from the scope of the present invention are the cementitious glass materials disclosed in U.S. Pat. Nos. 4,440,576, 3,720,527, and 3,743,525. Each of these patents discloses a cementitious material referred to as a “glass”, but in fact the material disclosed in each of these patents is very different from the common glass material formed into a powder and used in the present invention.

In each of these patents, a unique species of SiO₂-containing material having cementitious properties is produced as a result of the following special formulation and processing steps. First, the SiO₂-containing materials are specially formulated to incorporate certain special metal oxides to enhance their binding properties, such as K₂O and P₂O₅, in concentrations far higher than they would be found in conventional glass materials. This composition is then mixed together to form a ceramic mix, heated and melted to a temperature of between 1500° C. and 1700° C., and then rapidly cooled to form a supercooled glass structure. Thus, the resulting material is a specialized structural material that is a “glass” only in a specific physical and chemical sense, i.e. it is an amorphous solid lacking long-range order and containing SiO₂. It is not a “glass” as the term is most typically used to generically refer to common structural materials such as silicate glass, soda-lime glass, borosilicate glass, and lead glass as described above. Thus, the “glass” in U.S. Pat. Nos. 4,440,576, 3,720,527, and 3,743,525 is a specially formulated and processed amorphous solid that has hydraulic and cementitious properties, while in the present invention the glass material is common commercial glass material.

The source of the glass material is not critical to the present invention, and may even include freshly manufactured glass, but it is preferred that the glass material be post-consumer waste glass, as this may increase the cost-effectiveness and economic viability of the presently disclosed materials as well as provide an alternative to dumping the waste glass in landfills. By “post-consumer waste glass” is meant glass that is no longer necessary to perform the function for which it was formulated and formed. Glass containers that have been emptied of a consumable product, as well as glass containers or other glass articles that are broken or no longer usable for some other reason are all examples of post-consumer waste glass.

After the glass material is obtained and thoroughly cleaned, it is crushed, ground, pulverized or otherwise processed into glass powder. Various types of crushing and grinding equipment and other like equipment can be used to produce particulate glass powders. Examples of such equipment include the ball-medium type, medium agitating type, fluid-energy type, impact-pulverizing type, and other like machines. It is preferred that substantially all of the glass particles used in the present invention will pass through a No. 70 mesh sieve (as designated in the U.S. Sieve Series), and it is more preferred that about 80% to about 100% of the glass particles, by weight, will pass through a No. 100 mesh sieve. Particle size can be conveniently measured by using a series of vibrating screens stacked upon top of each other. This method is discussed in greater detail in ASTM Protocol E11-95 (“Standard Specification for Wire Cloth and Sieves for Testing Purposes”) and Perry's Chemical Engineering Handbook, pages 21-13-21-17, Table 21-6; 6th Ed., McGraw-Hill, Inc., New York, N.Y. (1984). This small particle size of the glass powder is preferred because it increases the surface area on which the reaction between the cement, activator or activators, and glass powder occur, thus increasing the rate of reaction.

It is an essential feature that the cementitious compositions of the present invention also include alkali metal aluminate, preferably sodium aluminate (NaAlO₂) or potassium aluminate (KAlO₂). The alkali metal aluminate component, which functions as an activator, may be added in either liquid or dry powder form. Optionally a co-activator may be added along with the alkali metal aluminate to enhance activation of the glass material. Suitable co-activators include alkali metal silicates, sodium carbonate, and alkali hydroxides or salts of alkali hydroxides. Preferred alkali metal silicates include lithium silicate, sodium silicate and sodium polysilicate.

Along with the alkali metal aluminate and the glass powder, the cementitious compositions also include cement. The most preferred cements are Portland cement and high alumina cement or a mixture of these cements.

The present cementitious compositions may also include optional cement additives. A particularly suitable additive is a superplasticizer (also known as water-reducer). Superplasticizer compounds reduce the amount of water necessary to mix with the cement composition to produce a cementitious binder of acceptable workability and thus increase the strength of concrete products formed from such cement. Conventional superplasticizers include lignosulfonate derivatives, condensed naphthalene sulfonates, or carbohydrate esters. POZZOLITH 440-N™ produced by Master Builders Technologies and DARACEM 100™ produced by the W. R. Grace & Co. are suitable commercially available examples of superplasticizers.

Other suitable additives include retardants, which delay setting time and are particularly useful for forming operations in high-temperature environments, and accelerants, which accelerate setting times and are useful for forming in low-temperature environments. Air entrainers, which improve workability, may also be used.

The cementitious compositions of the present invention preferably include about 30% to about 80% of a particulate inorganic cement; about 20% to about 70% of glass powder as a pozzolan; and about 0.1% to about 10% of alkali metal aluminate.

In actual use, the present cementitious compositions are mixed with water to form a cementitious binder composition, which can be solidified or used as the basis for a solidifiable cementitious composition. The weight ratio of water to cement in the binder is from about 0.1:1 to about 1:1, preferably about 0.3:1 to about 0.5:1.

These cementitious binder compositions may be mixed with mineral aggregate particles to form a solidifiable cementitious composition, such as a concrete or mortar. This binder forms a matrix in concrete or mortar products to hold together the aggregate particles. Aggregate particles are inert solid bodies that form most of the volume of a concrete article. When mixed with aggregate, the cementitious binder composition forms a binder matrix that holds the aggregate together. Additionally, mineral fillers such as silica flour, kaolin, shales, bentonites, feldspar and the like can be added in various amounts as extenders and to enhance physical properties.

Such solidifiable cementitious compositions are typically classified as concretes or mortars, depending on the particle size of the aggregate. Concretes usually contain both coarse and fine aggregates, whereas mortars contain fine aggregate but no coarse aggregate. The proportions of coarse and fine aggregate used in a concrete depend on the required properties and intended use, which are well-known to those of ordinary skill in the art.

Aggregates for use in concrete are described in ASTM C33-90 “Standard Specification for Concrete Aggregates”. In general, coarse aggregates, which include gravel and crushed limestone, fall within the range of 2 inches to ⅔ inch mesh; and fine aggregates, such as sand, fall in the range of No. 4 mesh to No. 200 mesh of ASTM C-11.

In addition, fibers or other strength-enhancing additives commonly-known to those skilled in the art can be added to the present solidifiable cementitious compositions to enhance the tensile strength, impact resistance or beneficially affect other important properties. Particularly useful are ferro-cement composites in which shapes of reinforcing metal bars or rods are embedded in the solidifiable cementitious compositions. As the concrete cures, the reinforcing bars and the concrete bond together. A particularly preferred reinforcing material is a ribbed steel rod coated with an epoxy to prevent corrosion. During usage of this ferro-cement composite, when a tensile force is applied to the concrete it is transferred to the reinforcing bars. In addition or alternatively to using metal reinforcing rods, a metal wire mesh may also be used as the reinforcement material. The use of reinforcing metallic rods and/or meshes may also be used in mortars, as well as in concretes. Suitable fibers include steel or polymeric fibers (e.g., nylon fibers).

The cementitious compositions of the present invention, as well as the cementitious binders and the solidifiable cementitious compositions produced from these cementitious compositions, may be made by using any standard mixing and forming processes commonly-known to those skilled in the art. The manner of combining and mixing ingredients to form the hydraulic cement compositions and the cementitious binders and solidifiable compositions is not restricted to any particular embodiment. These components may be mixed and combined in any order, at a variety of different temperatures and in a variety of different machine and apparatus configurations according to the needs of the user. The present invention also contemplates the use of suitable inter-grinding processes, i.e., grinding of the unmixed combination of the ingredients together into a mixture, so that mixing occurs simultaneously with grinding. An example of this is when the glass material is ground into powder along with the cement clinker.

After the cement and aggregate are mixed to form a solidifiable cementitious composition, such as a concrete or mortar mix, the solidifiable composition is “placed”, meaning it is poured, pressed, or otherwise processed into the shape into which it is to set or “solidify”. The solidifiable cementitious composition may be placed by pouring it into a wooden or steel form so that it hardens into the desired shape. Alternatively, the solidifiable cementitious composition may be placed by hand-troweling it into the desired shape. The solidifiable cementitious composition that has “set” or “hardened” into its desired shape may be referred to as the “solidified solidifiable cementitious composition”.

The process for setting and hardening of the solidifiable cementitious composition into the solidified solidifiable cementitious composition is not restricted to any particular embodiment, and any suitable process known to those of ordinary skill in the art may be used. The preferred process includes applying a protective medium to retain moisture, wet curing, or autoclave curing. The use of higher curing temperatures and higher amounts of relative humidity during curing accelerates the rate of hardening and allows for high compressive strengths to be more rapidly attained. The degree of relative humidity preferably exceeds 90%. Curing temperatures of over about 22° C. (room temperature) are suitable, preferably the curing temperature exceeds about 85° C., more preferably the curing temperature exceeds about 200° C.

It is preferable that, after curing, a solidified and cured solidifiable cementitious composition prepared according to the present invention has a compressive strength of at least about 45 MPa.

By formulating and processing cementitious compositions as described above, it has been determined that waste glass can be used as a pozzolan and a partial replacement for a portion of the cement in the cementitious composition, so that solidified concrete and mortar products made from such a cementitious composition have short-term and long-term strength properties superior to the strength properties of similar products made with conventional cements.

Additionally, solidifiable cementitious compositions made from these cementitious compositions may have a desirable “white” color. White cement or white concrete is highly desirable for use in applications where aesthetics and design appeal are an important factor. Thus, the present formulations for cementitious compositions offer many benefits over the conventional cement compositions that are well-known in the art.

As the solidifiable cementitious composition (in the form of mortars, concretes, and the like) hardens over time it gains superior strength as well as excellent durability compared to mortar and concretes made with conventional cements. It is suggested that the gain in strength is attributed to the continuous formation of additional stable calcium compounds from the lime released by the cement. Further, it is suggested that the excellent durability is related to the stabilization of the cement lime, which would otherwise react with chemicals in the environment to weaken the solidified concrete or mortar products made from the cementitious composition.

The invention will now be described in more detail with respect to the following specific, non-limiting examples.

### EXAMPLE I

Tests were carried out to determine the early strength properties of cementitious binder compositions containing different formulations of cement, glass powder and an alkaline metal aluminate (viz., sodium aluminate), as well as to determine the early (24 hours) and 7 days strength of solidifiable cementitious compositions (i.e., mortars), which are a combination of the aforementioned cementitious binder compositions, an aggregate and other optional components such as reinforcing fiber materials.

Several different solidifiable cementitious compositions and cementitious binder compositions were prepared according to ASTM C109/C-109M-99. In the control composition, 100% of the cementitious material was Portland cement. In compositions 1-7, from 50% to 70% of the Portland cement was replaced with a mixture of glass powder and an alkali metal aluminate, specifically sodium aluminate. Compositions 3 and 5 also included steel or nylon reinforcing fibers, to increase compressive strength, impact strength, and durability. The superplasticizer used was DARCEM 100®.

Tables I and II below set forth the precise formulations for each composition, wherein the amounts are in weight parts:

TABLE I

| | Composition 1 | Composition 2 | Composition 3 |
|---|---|---|---|
| Portland Cement | 255 | 170 | 255 |
| Glass Powder | 595 | 397 | 595 |
| Sodium Aluminate | 3.4 | 2.3 | 3.4 |
| (NaAlO₂) | | | |
| Water | 212.5 | 159 | 238 |
| Sand Aggregate | 0.0 | 283 | 170 |
| Superplasticizer | 6.4 | 4.3 | 6.4 |
| 0.75 inch Nylon Fibers | 0.0 | 0.0 | 2.3 |
| Total Cementitious | 850 | 567 | 850 |
| Composition | | | |
| Water to Cementitious | 0.25 | 0.28 | 0.28 |
| Ratio | | | |
| Wt % of Cementitious | 70% | 70% | 70% |
| composition that is | | | |
| glass | | | |
| Wt % of Cementitious | 0.40% | 0.40% | 0.40% |
| composition that is | | | |
| NaAlO₂ | | | |

TABLE II

| | Com- | Com- | Com- | Com- |
|---|---|---|---|---|
| | position | position | position | position |
| | 4 | 5 | 6 | 7 |
| Portland Cement | 435 | 425 | 260 | 121 |
| Glass Powder | 435 | 425 | 260 | 121 |
| Sodium Aluminate NaAlO₂ | 1.7 | 1.7 | 1 | 0.5 |
| Water | 261 | 255 | 157 | 85 |
| Sand Aggregate | 0.0 | 170 | 1623 | 219 |
| Gravel Aggregate | 0.0 | 0.0 | 415 | 510 |
| Superplasticizer | 0.0 | 8.5 | 0.0 | 2.4 |
| 0.5 inch Steel Fibers | 0.0 | 16.7 | 0.0 | 0.0 |
| Total Cementitious | 870 | 850 | 520 | 242 |
| Composition | | | | |
| Water to Cementitious Ratio | 0.30 | 0.30 | 0.30 | 0.35 |
| Wt % of Cementitious | 50% | 50% | 50% | 50% |
| composition that is glass | | | | |
| Wt % of Cementitious | 0.20% | 0.20% | 0.20% | 0.20% |
| composition that is NaAlO₂ | | | | |

In preparing the above cementitious binder compositions and solidifiable cementitious compositions, the glass material consisted of cleaned, post-consumer mixed color waste glass ground into a powder such that 80% to 100% passed through a No. 325 (U.S.) mesh sieve. The sodium aluminate was also prepared to pass through a No. 325 mesh sieve. Various water-cementitious composition weight ratios were used as indicated in the Tables. As directed by ASTM C109/C109 M-99, the materials for each of the compositions were first mixed together with water in a laboratory mixer to obtain a homogeneous cementitious binder composition. In compositions 2-3 and 5-7, sand or a mixture of sand and gravel aggregate was then added to further form a solidifiable cementitious composition. In all of the compositions in which it was used, the superplasticizer was the last ingredient added to the composition.

Also as per ASTM C 109/C 109M-99 the compositions were placed into 2 inch cube molds and compacted to eliminate entrapped air pockets. As set forth in Table III, one set of cubes was moist cured at room temperature and 100% humidity for 12 hours to solidify, and then further steam cured for an additional 8 hours at 85° C. A second set of cubes was cured at 22° C. and 100% relative humidity for 7 days. Each cube was then tested for compressive strength using a standard universal testing machine, as directed by ASTM C 109/C 109M-99.

The results were as follows.

TABLE III

| | Compressive Strength | |
|---|---|---|
| | (MPa) after being moist | |
| | cured at room temperature | Compressive Strength |
| | for 12 hours and then | (MPa) after being cured at |
| | steam cured at 85° C. | 100% relative humidity |
| | for 8 hours | and 22° C. for seven days |
| Composition 1 | 56.5 | 37.2 |
| Composition 2 | 50.3 | 31.0 |
| Composition 3 | 46.2 | 30.7 |
| Composition 4 | — | 41.0 |
| Composition 5 | 61.7 | 41.7 |
| Composition 6 | 55.2 | — |
| Composition 7 | 55.5 | — |

As can be seen from Table III, cementitious binder compositions and solidifiable cementitious compositions containing a mixture of Portland cement, sodium aluminate and glass powder had high compressive strength performance. The compressive strength performance of these compositions was superior to conventional compositions that contain Portland cement alone. This increase in the compressive strength of a cementitious composition or cementitious binder composition resulting from the use of Portland cement in combination with glass powder and sodium aluminate would not have been expected or predicted by those of skill in the art.

These data demonstrate that cementitious binder compositions formed from cementitious compositions comprising cement, glass powder and sodium aluminate have high early compressive strength that is comparable or superior to mortar and concrete products that are made from conventional cementitious compositions. Additionally, solidifiable cementitious compositions formed from cementitious binder compositions prepared according to the present invention have substantially improved early strength performance compared to mortar and concrete products that are made from conventional cementitious compositions that contain cement, but neither sodium aluminate or glass powder. Such results would be unexpected by one of ordinary skill in the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A cementitious composition comprising a cement, glass powder, and an alkali metal aluminate.

2. The cementitious composition according to claim 1, wherein the glass powder is selected from the group consisting of soda-lime glass, borosilicate glass, and lead glass.

3. The cementitious composition according to claim 1, wherein the alkali metal aluminate is selected from the group consisting of potassium aluminate and sodium aluminate.

4. The cementitious composition according to claim 1, wherein the glass powder comprises particles and substantially all of the particles pass through a No. 70 mesh sieve (U.S.).

5. The cementitious composition according to claim 1, wherein the glass powder comprises particles and wherein about 80% to about 100% of the particles, by weight, pass through a No. 100 mesh sieve (U.S.).

6. The cementitious composition according to claim 1, wherein the cement is selected from the group consisting of Portland cement, and high alumina cement.

7. The cementitious composition according to claim 1, comprising about 30% to about 80% of the cement, about 20% to about 70% of the glass powder, and about 0.1% to about 10% of an alkali metal aluminate.

8. The cementitious composition according to claim 1, wherein the glass powder comprises ground or pulverized post-consumer mixed waste glass.

9. A cementitious binder composition comprising water and the cementitious composition according to claim 1.

10. The cementitious binder composition according to claim 9, wherein the water and the cementitious composition are present in a weight ratio of about 0.1:1 to about 1:1.

11. The cementitious binder composition according to claim 9, wherein the water and the cementitious composition are present in a weight ratio of about 0.3:1 to about 0.5:1.

12. A solidifiable cementitious composition comprising the cementitious binder composition according to claim 9 and an aggregate.

13. The solidifiable cementitious composition according to claim 12 which is in the form of a mortar.

14. The solidifiable cementitious composition according to claim 12 which is in the form of a concrete.

15. A solidified and cured solidifiable cementitious composition according to claim 12, wherein after curing the solidified solidifiable cementitious composition has a compressive strength of at least about 45 MPa.
